(19) United States
(12) Patent Application Publication
(10) Pub. No.: US 2017/0091017 A1
(43) Pub. Date: Mar. 30, 2017

(54) FAULT DETECTING DEVICE AND METHOD

(71) Applicant: HON HAI PRECISION INDUSTRY CO., LTD., New Taipei (TW)

(72) Inventor: YU-CHEN HUANG, New Taipei (TW)

(21) Appl. No.: 14/922,934

(22) Filed: Oct. 26, 2015

(30) Foreign Application Priority Data
Sep. 29, 2015 (TW) 104131968

(51) Int. Cl. G06F 11/07

(52) U.S. Cl. CPC G06F 11/0793; G06F 11/0751; G06F 11/079

(57) ABSTRACT

A fault detecting device includes a baseboard management controller (BMC) coupled to a basic input and output system (BIOS) chip of a server. A BIOS is programmed in the BIOS chip. The BMC is used to receive signals of feedback of the BIOS. A plurality of kinds of faults and solutions for the plurality of kinds of faults are programmed in the BMC. When the BIOS chip outputs a signal, the BMC distinguishes what kind of fault the first signal indicates and executes a solution.

### FIELD

The subject matter herein generally relates to a method for detecting faults of servers and a device using the same.

### BACKGROUND

If a fault happens on a server when the server is booting and a basic input and output system of the server has not light a monitor, a user cannot find the fault directly.

### BRIEF DESCRIPTION OF THE DRAWINGS

Implementations of the present technology will now be described, by way of example only, with reference to the attached figures.

FIG. 1 is a block diagram of an embodiment of a fault detecting device of the present disclosure.

FIG. 2 is a flowchart of an embodiment of a method for detecting faults of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

The disclosure will now be described in relation to a fault detecting device.

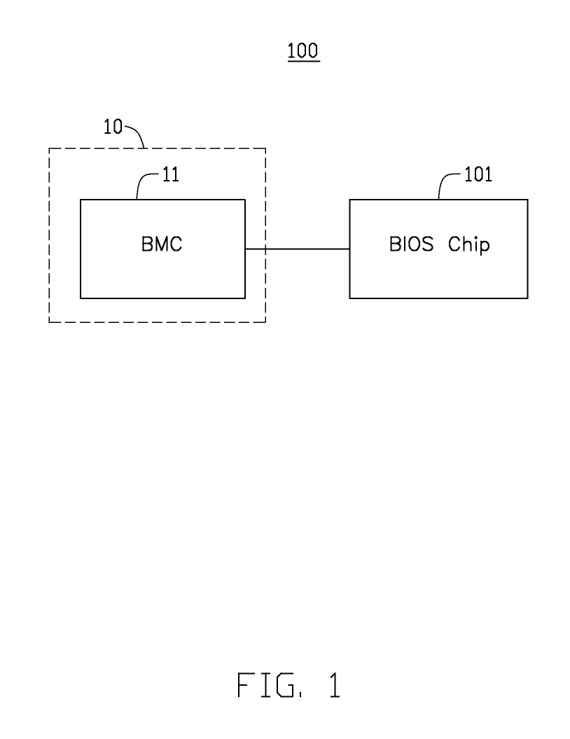

FIG. 1 illustrates a fault detecting device 10 used in a server 100.

The fault detecting device 10 can comprise a baseboard management controller (BMC) 11. The BMC 11 is coupled to a basic input and output system (BIOS) chip 101. A BIOS is programmed in the BIOS chip 101. The BMC 11 is configured to receive feedback signals of the BIOS. A plurality of kinds of faults and solutions for different kinds of faults are programmed in the BMC 11.

When the BIOS chip 11 outputs a first signal, the BMC 11 distinguishes what kind of fault the first signal indicates, then the BMC 11 executes a first solution.

In the embodiment, a first fault is a chassis intrusion. A first solution is configured to ensure the chassis is installed normally. The BMC 11 controls the BIOS to detect the fault when the chassis is installed normally.

A second fault is about an initialization of a CPU. A second solution is configured to write preset commands to registers and reboot the CPU.

A third fault is about a frequency of the CPU. A third solution is configured to check a present frequency of the CPU and write a preset frequency to the CPU when the present frequency is not the same as the preset frequency of the CPU.

A fourth fault is about a cache of the CPU. A fourth solution is configured to reset the cache of the CPU.

A fifth fault is about an initialization of a vision BIOS. A fifth solution is to check whether the server 100 comprises a discrete graphics. When the server 100 comprises a discrete graphics, the discrete graphics is rebooted. When the server 100 does not comprises a discrete graphics, the server 100 outputs signals of vision through the CPU.

A sixth fault is about an initialization of a memory. A sixth solution is configured to check a specification of the present memory and compare the specification of the present memory to a preset specification. When the specification of the present memory is not the same as the preset specification, the preset specification is corrected to be the specification of the present memory.

A seventh fault is about a capacity of the memory. A seventh solution is configured to read a capacity of the present memory through a read only memory of the memory and to compare the capacity of the present memory to a preset value. When the specification of the present memory is not the same as the preset value, the preset value is corrected to be the same as a value of the capacity of the present memory.

An eighth fault is about an initialization of a hard disk. An eighth solution is configured to check a controller of the hard disk.

A ninth fault is about a Peripheral Component Interconnect (PCI) device. A ninth solution is configured to check the PCI devices and output a status of the PCI devices to the BMC 11.

A tenth fault is about a Universal Serial Bus (USB) device. A tenth solution is configured to disable the USB device and to reboot the USB device.

An eleventh fault is a crash of the vision BIOS. An eleventh solution is to read a backup of the vision BIOS from a read only memory.

A twelfth fault is about a platform controller. A twelfth solution is configured to check whether the platform controller outputs a signal of feedback.

A thirteenth fault is about a node controller. A thirteenth solution is configured to test the node controller and update software of the node controller when the node controller operates abnormally.

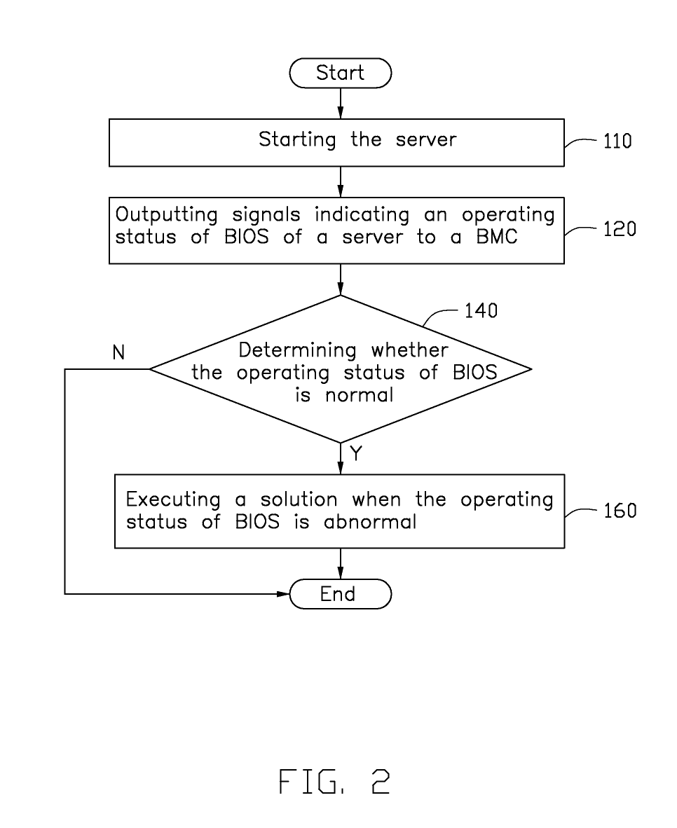

FIG. 2 illustrates a flowchart of an exemplary method for detecting a plurality of faults of the server 100. The example method is provided by way of example, as there are a variety of ways to carry out the method. The method described below can be carried out using the configurations illustrated in FIGS. 1-2, for example, and various elements of these figures are referenced in explaining the example method. Each block shown in FIG. 2 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block 110.

At block 110, the server boots and starts to operate.

At block 120, the BIOS chip outputs signals of feedback of the status of the BIOS to the BMC 11.

At block 140, the BMC 11 distinguishes whether the status of the BIOS is normal.

At block 160, the BMC 11 executes a solution correspondingly when the BIOS is operating abnormally.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A fault detecting device comprising:
a baseboard management controller (BMC) coupled to a basic input and output system (BIOS) chip of a server and is configured to have a plurality of kinds of faults programmed thereon;
wherein BIOS is programmed in the BIOS chip, the BMC is configured to receive signals of feedback of the BIOS from the BIOS chip;
wherein when the BIOS chip outputs a signal, the BMC determines what kind of fault the signal indicates and executes a solution from a plurality of solutions.

2. The fault detecting device as claim 1, wherein the first kind of fault is a chassis intrusion.

3. The fault detecting device as claim 1, wherein the first kind of fault is about an initialization of a CPU of the server.

4. A method for detecting fault of a server, comprising:
starting the server;
outputting signals indicating an operating status of BIOS of a server to a BMC;
determining whether the operating status of BIOS is normal; and
executing a solution when the operating status of BIOS is abnormal.
